(19) United States
(12) Patent Application Publication
(10) Pub. No.: US 2006/0142016 A1
(43) Pub. Date: Jun. 29, 2006

(54) Method for operating a mobile radio telephone system, mobile radio telephone system, mobile station and device for determining a sub-group of adjacent radio cells in a mobile radio telephone system

(76) Inventors: Rifat Can, Ulm (DE); Hans-Ulrich Flender, Ulm (DE); Andreas Frey, Wallenhorst (DE)

Correspondence Address: STAAS & HALSEY LLP, SUITE 700, 1201 NEW YORK AVENUE, N.W., WASHINGTON, DC, 20005, US

(21) Appl. No.: 10/529,371

(22) PCT Filed: Sep. 1, 2003
(86) PCT No.: PCT/EP03/09706

§ 371 Date: Mar. 28, 2005

(30) Foreign Application Priority Data
Sep. 27, 2002 (DE) 10245118.4

(51) Int. Cl. H04Q 7/20

(52) U.S. Cl. 455/449; 455/446

(57) ABSTRACT

A mobile radio telephone system has at least one first radio cell, several radio cells to that are adjacent to the first radio cell and base stations, each of the latter covering one of the radio cells. A sub-group of the adjacent radio cells is determined depending on the position of a mobile station in the first radio cell. The mobile station subsequently measures a quality parameter of only those signals of the base stations associated with the sub-groups of the adjacent radio cells. One possible advantage is that the time required to carry out the measurements is relatively short as a result of the reduction of their number.

### CROSS REFERENCE TO RELATED APPLICATIONS

This application is based on and hereby claims priority to PCT Application No. PCT/EP2003/009706 filed on Sep. 1, 2003 and German Application No. 102 45 118.4 filed on Sep. 27, 2002, the contents of which are hereby incorporated by reference.

### BACKGROUND OF THE INVENTION

The invention relates to a method for operating a mobile radio system, a mobile radio system, a mobile station and a device for determining a sub-group of adjacent radio cells in a mobile radio system.

Cellular mobile radio systems generally have a large number of respectively adjacent radio cells, each covered by a base station. One base station with directional sector antennae can also cover a plurality of radio cells. Mobile stations in one of the radio cells generally communicate with the base station of the relevant radio cell. If however the transmission capacities of the respective base station are exhausted, or if the transmission quality to the base station is impaired, because for example the mobile station is at the edge of the respective radio cell and therefore relatively far away from the base station, or if the mobile station changes location to an adjacent radio cell, it is necessary for communication to be set up between the mobile station and a new base station of one of the adjacent radio cells. In order to decide the new base station with which or new radio cell in which communication is to be set up with the mobile station, the mobile station generally receives signals transmitted on the control channels of all adjacent base stations and analyzes their receive quality. A decision can then be made on the basis of these measurement results as to the new base station with which the mobile station should establish communication.

Known cellular mobile radio systems currently operate for example according to the GSM (Global System of Mobile Communication) standard or will operate in future according to the third generation standard UMTS (Universal Mobile Telecommunications Standard). There is often provision when the mobile station changes from a first radio cell to an adjacent cell for the signals of all the base stations adjacent to the first radio cell to be measured.

### SUMMARY OF THE INVENTION

One possible object is to improve implementation of the measurement of signals from base stations in adjacent cells, as implemented for example before the implementation of a cell change by a mobile station.

The inventors propose to operate a mobile radio system with at least a first radio cell and a plurality of radio cells adjacent to the first radio cell, covered respectively by a base station, a sub-group of the adjacent radio cells is determined as a function of the position of a mobile station within the first radio cell and the mobile station then implements measurements of a quality parameter of signals of the base stations of just this sub-group of the adjacent radio cells.

The sub-group of the adjacent radio cells can thereby be selected such that for the specific position within the first radio cell the signals received from its base stations have a better receive quality than signals originating from the base stations of the other adjacent radio cells, which do not belong to the sub-group. The sub-group can therefore be determined in advance (i.e. before implementation of the measurements by the mobile station) by corresponding sample measurements at the specific position. The signals of all adjacent radio cells are analyzed for these sample measurements, allowing the sub-group of the adjacent radio cells with the best measurement results to be determined.

The results of the sample measurements are used to determine the sub-groups. Corresponding sub-group information for each sub-group can be stored in a network-side component.

The sub-group can however also be defined irrespective of measurement results additionally or solely based on network planning considerations. This prevents an adjacent radio cell being assigned to the sub-group, for which good receive conditions result by chance beforehand at the respective position within the first radio cell but which are unsuitable for any cell change (handover) to be implemented.

The method and device have the advantage that the number of measurements to be implemented is limited to the radio cells of the sub-group and not all the adjacent radio cells have to be measured. This allows a reduction in the time required for the measurements and the computation outlay. As the signals of a plurality of adjacent cells can generally only be measured one after the other, the method and device allow the entire measuring process to be shortened. Also the power consumption of the mobile station implementing the measurements is reduced. In an extreme instance the sub-group may only contain one of the adjacent radio cells.

The adjacent radio cells may belong to the same mobile radio network as the first radio cell. It is also possible for them to belong to another mobile radio network (in some instances of another network operator). In this case the mobile radio system is formed by both mobile radio networks. Their radio cells can be overlaid locally on each other. The two mobile radio networks can be operated according to different standards, e.g. GSM and UMTS.

It is also possible (irrespective of whether the radio cells belong to the same or different networks) for the first radio cell and the adjacent radio cells to be operated in different frequency ranges. They may however also be operated in the same frequency range.

The sizes of the radio cells can be the same or different.

The method and device can advantageously be used when implementing measurements in preparation for a cell change by the mobile station (handover).

“Position” refers to a local area, of specific extension. The first radio cell can therefore be sub-divided into two or more sub-areas, the sub-group of the adjacent radio cells being defined for one of these sub-areas.

The method includes the instance where a plurality of radio cells is covered by a common base station, which covers the radio cells as spatially separated sectors with directional antennae. The base station transmits different signals for each of these radio cells.

The quality parameter defined by the mobile station for the signals received by the mobile station from the adjacent base stations can for example be received power or signal to noise ratio. Other parameters can also be considered, in particular those which can influence a decision about a cell change.

According to a development, another sub-group of the adjacent radio cells is determined in each instance for the measurements to be implemented before the measurements are implemented for different positions of mobile stations within the first radio cell. When the first radio cell is sub-divided into geographical sub-areas this allows an individual sub-group of the adjacent radio cells to be assigned to each sub-area for the measurements to be implemented, it being possible to determine each sub-group such that in the respective sub-area the signals of its base stations provide better measurement results from the mobile station than is the case for the other adjacent cells.

According to a development the base station of the first radio cell transmits sub-group information to the mobile station, which is used to determine the sub-group of the adjacent radio cells. In this way the mobile station is informed which adjacent cells belong to the sub-group for which the mobile station is to implement measurements.

According to a development the sub-group information specifies another sub-group of the adjacent radio cells in each instance for different possible positions of mobile stations in the radio cell. The mobile stations determine their actual position within the first radio cell and then identify the sub-group from the position determined and the sub-group information obtained. This allows independent selection by the mobile station of the sub-group of relevance to it from the sub-group information communicated based on the position determined automatically by the mobile station. The position can for example be determined by a GPS receiver of the mobile station.

According to an alternative embodiment the actual position of the mobile station is determined. The sub-group information is then generated taking into account the determined position and transmitted from the base station of the first radio cell to the mobile station. The position of the mobile station can thereby be determined by the base station by known position determining methods, which are known to the person skilled in the art. Examples of these are triangulation methods, implemented for example according to the OTDOA (Observed Time Difference Of Arrival) method.

The base station of the first radio cell can use a directional antenna to transmit the sub-group information. It is then possible to transmit sub-group information in different directions for different sub-groups respectively. All mobile stations, which receive such directional sub-group information, then only measure the signals of the adjacent radio cells of the sub-group communicated to them in each instance. The transmission direction for the respective sub-group information must therefore correspond to the sub-area, for which the respective sub-group was determined beforehand.

According to a development two groups of respectively adjacent radio cells are overlaid locally on each other in the mobile radio system, the first radio cell belonging to the first group and the sub-group of the radio cells adjacent to it belonging to the second group. The mobile station implements measurements of a quality parameter for signals from the base stations of at least some of the immediately adjacent radio cells of the first group in the first radio cell. It is then ascertained which of these adjacent radio cells of the first group gives the best measurement results for the current position of the mobile station. This can either be done by the mobile station itself or by a network-side component, which informs the mobile station of the measurement results. The sub-group of radio cells of the second group is then determined on the basis of the radio cells of the first group with the best measurement results. The mobile station then implements measurements of the quality parameter of the signals of the base stations of just this sub-group of the adjacent cells of the second group.

The sub-group of the adjacent radio cells of the second group is thus determined in the described manner on the basis of measurements of signals from radio cells of the first group. It is possible to assign to the sub-group for example those radio cells of the second group, which are at a defined distance from the radio cells of the first group with the best measurement results. This development is particularly advantageous, when the radio cells of the first group are operated in a different frequency range and/or belong to a different mobile radio network from the radio cells of the second group. In the event of an anticipated cell change (handover) only the signals of the radio cells in the same frequency range or in the same mobile radio network are then generally measured. If however in the event of a cell change the change is to a radio cell of the second group, the measurement results of the signals of the first group can advantageously be used to reduce the number of measurements to be implemented of signals from the radio cells of the second group.

According to a development the radio cells of the second group are smaller than the radio cells of the first group. This means that in the event of a cell change from the first radio cell to a radio cell of the second group, a larger number of signals are present from the adjacent base stations than in the event of a cell change to a radio cell of the first group. The smaller number of signals of the adjacent radio cells of the first group can therefore be measured, to use the measurement results thus obtained in the described fashion to determine the sub-group of the radio cells of the second group, so that only the signals of the sub-group of the second group of radio cells have to be evaluated by the mobile station.

The mobile radio system, the mobile station for a mobile radio system and the device for determining a sub-group of adjacent radio cells for a mobile radio system have the components required to implement the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first group of radio cells in a mobile radio system,

FIG. 2 shows another representation of the radio cells from FIG. 1 with measurement points marked,

FIG. 3 shows a second group of radio cells of the mobile radio system from FIG. 1 overlaid locally on the first group,

FIG. 4 shows an assignment of radio cells of the first group to radio cells of the second group,

FIG. 5 shows the determination of different sub-groups within the second group of radio cells and

FIG. 6 shows different signals, which are transmitted between base stations and mobile stations of the mobile radio system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

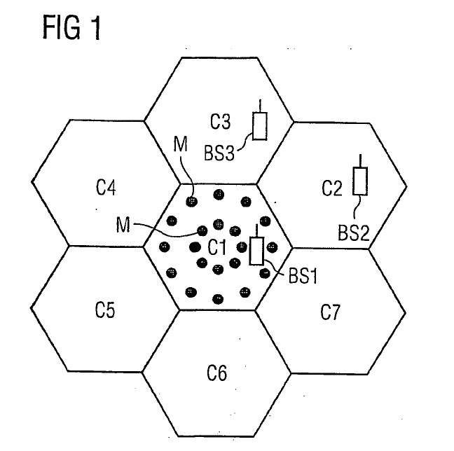

FIG. 1 shows a section of a mobile radio system according to one possible embodiment of the invention. It is a mobile radio system according to the UMTS-FDD (Frequency Division Duplex) standard. It is a cellular mobile radio system, in which a large number of respectively adjacent radio cells allow blanket coverage of the mobile users. FIG. 1 shows seven radio cells C1 to C7. A base station BS1, BS2, BS3 . . . is assigned to each radio cell to cover the respective radio cell C1 to C7. FIG. 1 only shows the first three base stations BS1 to BS3. The base stations can either be arranged centrally in the center of the respective radio cell or at the boundary points of three of the radio cells respectively and emit their signals from there into the respective radio cell by directional antennae. In the latter instance a plurality of radio cells can also be covered by a common base station with sector antennae.

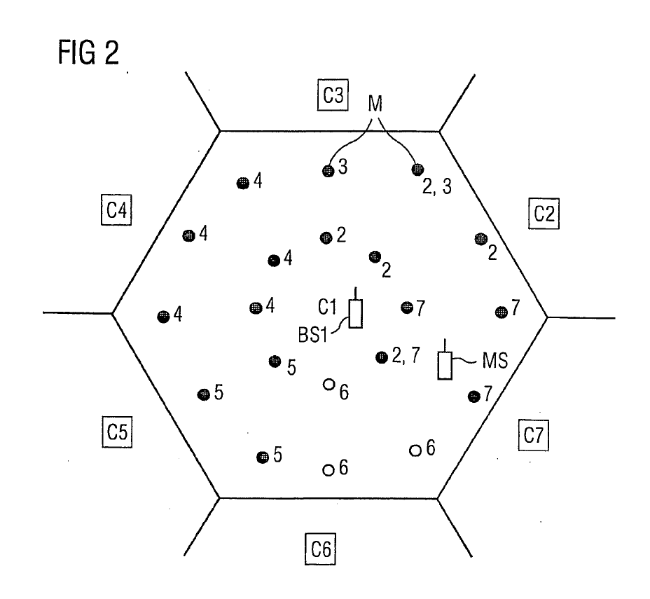

FIG. 1 shows a plurality of measurement points M within the first radio cell C1, which are examined in more detail below with reference to FIG. 2.

FIG. 2 shows an enlargement of the radio cells C1 to C7 from FIG. 1. The measurement points M are again shown within the first radio cell C1. It has been established for each individual measurement point M using a suitable measuring device, which in principle can be constructed as a mobile station of the mobile radio station, for which of the adjacent radio cells C2 to C7 the highest received power results at the respective location for signals, which the base stations BS2, BS3 . . . of the adjacent cells C2 to C7 broadcast on a control channel.

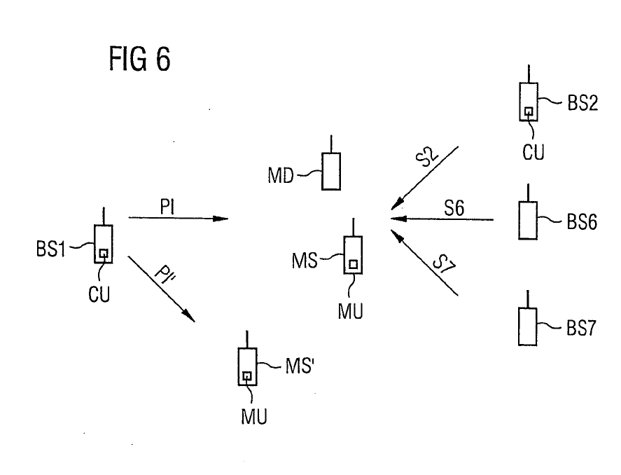

A possible implementation of these measurements at the measurement points M is described with reference to FIG. 6. A measuring device MD, located within the first radio cell C1 in the position of the respective measurement point M, receives signals S2, S6, S7 of the control channels of all adjacent radio cells C2 to C7 there. FIG. 6 shows only three of these signals S2, S6, S7. The measuring device MD now determines the signal(s) with the highest received power.

In addition to each measurement point M, FIG. 2 shows the adjacent radio cells C2 to C7, for which the highest received power values resulted during the measurement described above. For example a “2” next to the measurement point M means that for transmissions from the second base station BS2 of the second radio cell C2 the highest received power resulted at the respective measurement point M.

The preparation for a cell change by a mobile station MS from the first radio cell C1 to one of the adjacent radio cells C2 to C7 is described below. According to FIG. 2 the mobile station MS is located in the lower right area of the first radio cell C1. It is thus located in a position within a sub-area of the first radio cell C1, for which the measurement points M contained therein have the adjacent cells C2, C6 and C7 as the adjacent cells with the highest received power for their signals S2, S6, S7. These adjacent cells form a sub-group. The mobile station MS takes account of corresponding sub-group information and as preparation for its cell change only measures the signals S2, S6, S7 of this sub-group C2, C6, C7 of the adjacent cells C2 to C7 of the first radio cell C1.

According to FIG. 6 the mobile station MS receives sub-group information from the first base station BS1 of the first radio cell C1, allowing it to identify the sub-group of the adjacent cells C2 to C7 corresponding to its position within the radio cell C1. In the exemplary embodiment under consideration here the base station BS1 of the first radio cell C1 knows the position of the mobile station MS and sends it the sub-group information PI for this position. A further mobile station MS′ receives sub-group information PI′ tailored to its individual position within the first radio cell C1.

In a different embodiment the mobile station MS, MS′ can also determine its position itself, for example using a GPS receiver. The base station BS1 can then transmit the same sub-group information PI to all the mobile stations MS, MS′, from which different sub-groups can be derived for different sub-areas of or positions in the first radio cell C1. Each mobile station MS, MS′ can then use its own position within the sub-group information as determined by it to identify the sub-group of significance for it.

With yet another embodiment it is also possible for neither the first base station BS1 nor the mobile stations MS, MS′ to have to have knowledge of the position of the mobile station. Instead the first base station BS1 transmits the respectively tailored information into the sub-areas of the first radio cell C1 corresponding to the respective different sub-groups of the adjacent radio cells C2 to C7 by a directional antenna, the sub-group information serving to identify the corresponding sub-group.

The first base station BS1 in FIG. 6 has a device CU for determining the sub-group C2, C6, C7, which to this end takes into account the measurement results at the measurement points M shown in FIG. 2. With other embodiments the device CU can of course be arranged outside the first base station BS1. It can in particular be arranged in a central unit of the mobile radio system, which is connected to a plurality of base stations BS1, BS2, BS3 . . . and is responsible for determining the different sub-groups for these base stations.

The mobile station MS in FIG. 6 has a measuring unit MU, which is used to implement the measurements relating to the signals S2, S6, S7 of the sub-group C2, C6, C7 of adjacent radio cells. The measuring unit MU thereby implements the the measurements after evaluating the sub-group information PI transmitted to it.

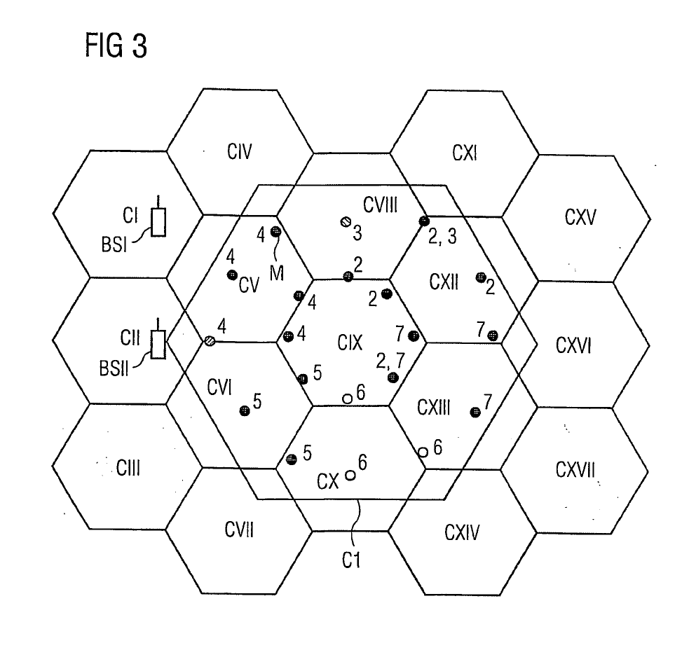

FIG. 3 shows a second group of radio cells CI to CXVII of the mobile radio system from FIG. 1 for a second possible embodiment. The radio cells of the second group are smaller than the radio cells of the first group shown in FIG. 1. The radio cells of the second group may belong to a different mobile radio network from the radio cells of the first group. Both networks together are however referred to here as a mobile radio system. The radio cells of the second group can be operated according to a different mobile radio standard from those of the first group, e.g. the GSM standard.

Each radio cell CI to CXVII of the second group is in turn assigned a base station BSI, BSII . . . , of which only the first two are shown in FIG. 3.

The radio cells CI to CXVII of the second group are overlaid locally on the radio cells C1 to C7 of the first group. FIG. 3 only shows the locally overlaid first radio cell C1 from FIG. 1. The measurement points M with the measurement results from FIG. 2 are in turn shown within the radio cell C1 in FIG. 3. With this exemplary embodiment the radio cells C1 to C7 of the first group are operated in a different frequency range from the radio cells C1 to cells are however operated according to the UMTS-FDD standard. They are therefore locally overlaid macrocells C1 to C7 and microcells CI to CXVII.

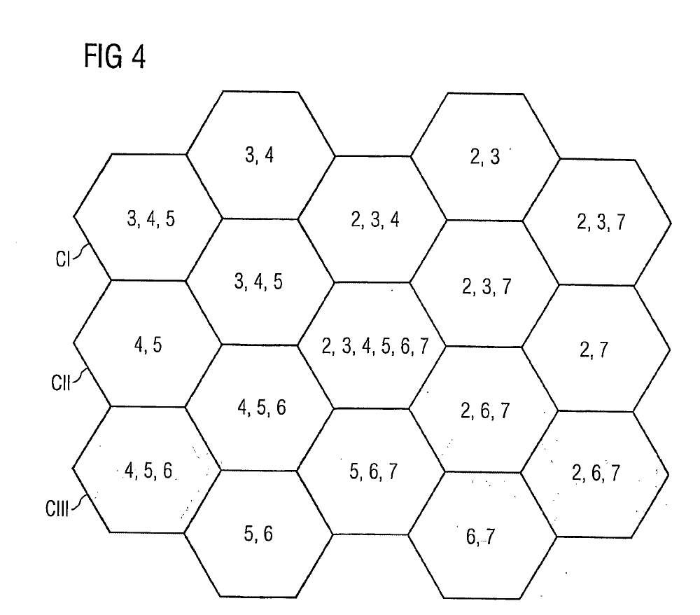

FIG. 4 again shows the second group of radio cells CI to CXVII. According to the measurement points M and the associated measurement results, each of the radio cells CI to CXVII of the second group was assigned one or more of the radio cells C2 to C7 of the first group.

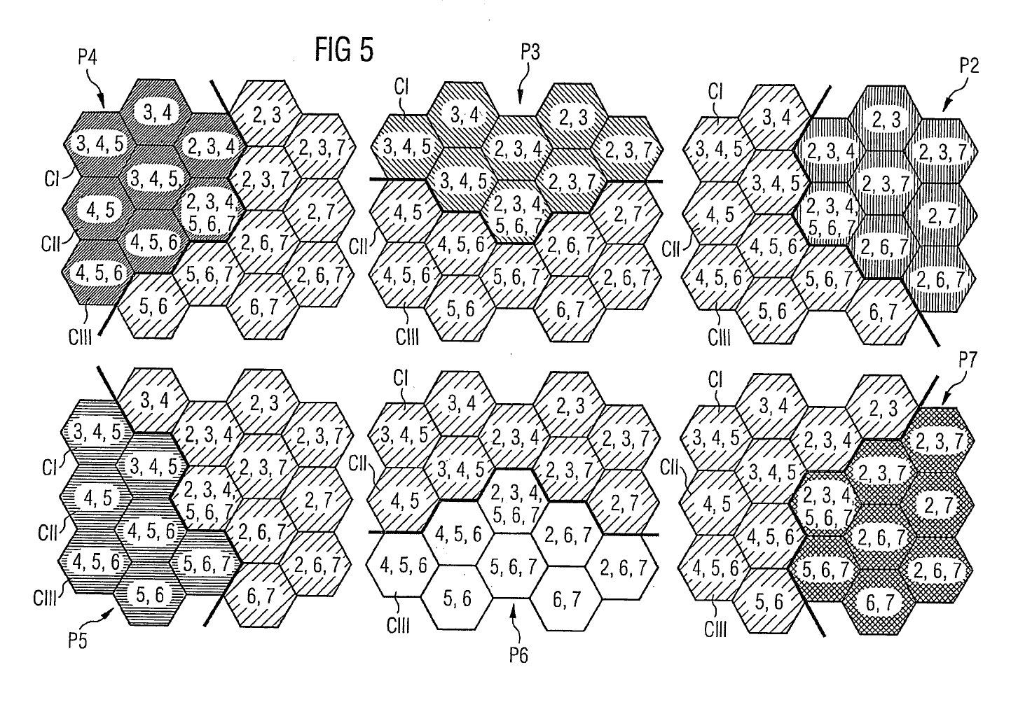

FIG. 5 shows six different sub-groups P2 to P7, which are formed within the radio cells CI to CXVII. The sub-group P4 in the first row on the left in FIG. 5 is assigned to a mobile station MS, if the mobile station is located in a sub-area of the first radio cell C1, for which the measurements of the mobile station MS have determined the radio cell C4 of the first group to be the strongest radio cell. The sub-group P3 in the center of the first line in FIG. 5 contains the radio cells of the second group, which are assigned to a sub-area of the first radio cell C1, in which the measurement results have determined the third radio cell C3 of the first group as the strongest radio cell. The same applies correspondingly to the other sub-groups P2, P5, P6, P7 in FIG. 5. Each sub-group P2 to P7 in FIG. 5 has only half of the in total 17 radio cells CI to CXVII of the second group.

The corresponding sub-group P2 to P7 in FIG. 5 is now selected based on the position of the mobile station MS within the first radio cell C1. If the mobile station MS is for example in the position shown in FIG. 2, i.e. in a sub-area of the first radio cell C1, in which the seventh radio cell C7 of the first group is received best, the sub-group P7 in the second line on the right of FIG. 5 is selected. To prepare for a cell change from the first radio cell C1 to one of the radio cells CI to CXVII of the second group, the mobile station MS then only implements one measurement of the signals of the base stations of the sub-group P7 transmitted in the control channels to the radio cells of the second group. The mobile station MS therefore only measures eight of the total of seventeen radio cells CI to CXVII of the second group adjacent to the first radio cell C1.

With UMTS-FDD, so-called compressed mode is used to measure radio cells which operate in a different frequency range from the radio cell in which the mobile station is currently located. In compressed mode the data transmission has to be interrupted periodically to set the receiver to the other frequencies and to measure the adjacent cells. There is therefore less time available for actual data transmission. Also measurement of signals from potential destination cells takes a certain time, thereby delaying the cell change, which may be urgently required. While the measurement of adjacent cells operating in the same frequency range as the current cell can be implemented temporally parallel to the receipt of data, when measuring potential destination cells, which operate in a different frequency range or belong to another mobile radio network, the receipt of data must be interrupted. The method and device can reduce the length of the interruption.

The sub-groups P2 to P7 from FIG. 5 are in turn signaled as a function of the current position of the mobile station MS by corresponding sub-group information PI from the first base station BS1 to the mobile station MS (see also FIG. 6).

With other exemplary embodiments the sub-group information PI can also specify a specific selection rule for the sub-group of the adjacent radio cells to be measured. Such rules might for example be: “If radio cell A is the best within the first group, cells B and C of the second group should be measured” or “If cell A of the first group is the best cell, cells B and C of the second group should not be measured”. These rules can for example be signaled in the neighbor cell information list of the measurement control or in the neighbor cell information list of a system information block according to the UMTS-FDD standard.

It is also possible for the mobile station MS to determine the strongest adjacent cell C2 to C7 of the first group and inform the first base station BS1 of this, whereupon the corresponding adjacent cells of the sub-group to be measured are selected by the base station or a central unit within the mobile radio system based on this communication. In other words the sub-group to be measured is selected and signaled on the network side.

It is also possible for the mobile station MS to be informed by the sub-group information PI of the sequence in which the adjacent cells are to be measured. The sub-groups assigned to the possible positions of the mobile station MS can also be updated, in that the mobile station MS responds if it identifies an error in the assignment of a radio cell to the sub-group. If the first base station BS1 for example instructs the mobile station MS1 to measure three radio cells of a specific sub-group but the mobile station MS1 can only receive two of these radio cells, it informs the system of this, so that the radio cell that cannot be received is removed from the corresponding sub-group in future.

A further possible rule, of which the mobile station MS can be informed by the sub-group information PI, is: “If cells A and B of the first group are the strongest cells and cell C of the first group is the weakest cell, cell D of the second group 1 should be selected as the adjacent cell of the sub-group to be measured”.

With the second exemplary embodiment the position of the mobile station MS is determined indirectly by the mobile station itself. It determines the strongest adjacent cell C2 to C7 of the first group and then uses the sub-group information PI communicated to it by the first base station BS to determine the sub-group P2 to P7 of the second group of radio cells CI to CXVII to be measured. As the strongest adjacent cell of the first group C2 to C7 differs as a function of location for the respective position of the mobile station MS, with the second exemplary embodiment ascertaining the strongest adjacent cell involves indirect determination of the position of the mobile station MS. With the second exemplary embodiment therefore position determination by the first base station BS1 or using another position determining method (for example by a GPS receiver) is not required in the mobile station MS.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means one or more of A, B and C may be used, contrary to the holding in Superguide v. DIRECTV, 69 USPQ2d 1865 (Fed. Cir. 2004).

1-12. (canceled)

13. A method for operating a mobile radio system with a first group of adjacent radio cells and a second group of adjacent radio cells, the first and second groups of radio cells being overlaid on each other, comprising:
measuring signal quality from a mobile station, which is operating at a current position in a first radio cell of the first group, to other radio cells of the first group that are adjacent to the first cell;
determining which of other radio cells of the first group has the best signal quality for the current position of the mobile station;
identifying a sub-group of radio cells from the second group based on which radio cell of the first group has the best signal quality; and
measuring signal quality from the mobile station to the sub-group of radio cells from the second group but not to other radio cells of the second group that are not included in the subgroup.

14. The method according to claim 13, wherein
the radio cells of the second group are smaller than the radio cells of the first group.

15. The method according to claim 13, wherein
the radio cells of the first group are operated in a different frequency range from radio cells of the second group.

16. The method according to claim 13, wherein
if the current position of the mobile station changes, a new sub-group of radio cells from the second group is identified before measuring signal quality to radio cells of the second group.

17. The method according to claim 13, wherein
the sub-group of radio cells from the second group is identified based on sub-group information describing which radio cells of the second group have a close relationship with the radio cell of the first group which has the best signal quality, and
the base station of the first radio cell transmits the sub-group information to the mobile station.

18. The method according to claim 17, wherein
the sub-group information specifies different sub-groups of radio cells from the second group for different radio cells of the first group,
the mobile station determines its actual position within the first radio cell and determines which of the other radio cells of the first group has the best signal quality for the actual position, and
the mobile station identifies the sub-group from the determined position and the sub-group information.

19. The method according to claim 17, wherein
when the mobile station moves and there is a change in the radio cell of the first group having the best signal quality, new sub-group information is generated and transmitted from the base station of the first radio cell to the mobile station.

20. The method according to claim 17, wherein
the base station of the first radio cell uses a directional antenna to transmit the sub-group information.

21. The method according to claim 13, wherein
each radio cell is served by a base station, and
signal quality measurements are taken from the mobile station to the base stations serving the respective radio cells.

22. The method according to claim 21, wherein for a least a portion of the radio cells, a single base station served two or more radio cells.

23. The method according to claim 14, wherein
the radio cells of the first group are operated in a different frequency range from radio cells of the second group.

24. The method according to claim 23, wherein
if the current position of the mobile station changes, a new sub-group of radio cells from the second group is identified before measuring signal quality to radio cells of the second group.

25. The method according to claim 24, wherein
the sub-group of radio cells from the second group is identified based on sub-group information describing which radio cells of the second group have a close relationship with the radio cell of the first group which has the best signal quality, and
the base station of the first radio cell transmits the sub-group information to the mobile station.

26. The method according to claim 25, wherein
the sub-group information specifies different sub-groups of radio cells from the second group for different radio cells of the first group,
the mobile station determines its actual position within the first radio cell and determines which of the other radio cells of the first group has the best signal quality for the actual position, and
the mobile station identifies the sub-group from the determined position and the sub-group information.

27. The method according to claim 25, wherein
when the mobile station moves and there is a change in the radio cell of the first group having the best signal quality, new sub-group information is generated and transmitted from the base station of the first radio cell to the mobile station.

28. The method according to claim 25, wherein
the base station of the first radio cell uses a directional antenna to transmit the sub-group information.

29. A device to determine a sub-group of adjacent radio cells in a mobile radio system with a first group of adjacent radio cells and a second group of adjacent radio cells, the first and second groups of radio cells being overlaid on each other, comprising:
a first measurement unit to measure signal quality from a mobile station, which is operating at a current position in a first radio cell of the first group, to other radio cells of the first group that are adjacent to the first cell;
a determination unit to determine which of other radio cells of the first group has the best signal quality for the current position of the mobile station;
an identification unit to identify a sub-group of radio cells from the second group based on which radio cell of the first group has the best signal quality; and
a second measurement unit to measure signal quality from the mobile station to the sub-group of radio cells from the second group but not to other radio cells of the second group that are not included in the subgroup.
